(19) United States
(12) Patent Application Publication
(10) Pub. No.: US 2022/0300898 A1
(43) Pub. Date: Sep. 22, 2022

(54) DELIVERY REQUEST SYSTEM AND CONTROL METHOD OF DELIVERY REQUEST SYSTEM

(71) Applicant: HONDA MOTOR CO., LTD., Tokyo (JP)

(72) Inventor: Shintaro Aoyagi, Wako-shi (JP)

(21) Appl. No.: 17/690,743

(22) Filed: Mar. 9, 2022

(30) Foreign Application Priority Data
Mar. 16, 2021 (JP) 2021-042483

(51) Int. Cl. G06Q 10/08; G06Q 10/02; G06Q 30/04; G06Q 50/30

(52) U.S. Cl. CPC G06Q 10/0834; G06Q 10/0832; G06Q 10/02; G06Q 30/04; G06Q 50/30

(57) ABSTRACT

A delivery request system that requests a driver of a ride-share vehicle to deliver a fresh food, that extracts the deliverable ride-share vehicle, which is the ride-share vehicle capable of delivering the fresh food, based on a ride-share status of the ride-share vehicle, a position of the ride-share vehicle, and a delivery time or a delivery amount of the fresh food; and that makes a delivery request for the fresh food to the driver of the deliverable ride-share vehicle extracted by the deliverable ride-share vehicle extraction unit, wherein that extracts, as the deliverable ride-share vehicle, the ride-share vehicle being ride-shared at the delivery time, when a transportation influence time is within a predetermined time or when a loadable empty space is larger than a required delivery capacity, the transportation influence time being a time during which the delivery of the fresh food affects transportation of passengers.

### INCORPORATION BY REFERENCE

The present application claims priority under 35 U.S.C. § 119 to Japanese Patent Application No. 2021-042483 filed on Mar. 16, 2021. The content of the application is incorporated herein by reference in its entirety.

### BACKGROUND OF THE INVENTION

### Field of the Invention

The present invention relates to a delivery request system and a control method of the delivery request system.

### Description of the Related Art

In the related art, a delivery system is known in which a delivery request is made to an operator of a ride-share movable object. For example, Japanese Patent Laid-Open No. 2004-59213 discloses a delivery system that instructs a transport vehicle to deliver luggage based on a free time of a transport vehicle such as a taxi or a bus, or personnel.

By the way, when articles are delivered by a ride-share movable object such as a taxi, the article deliverable timing is not necessarily limited to the free time of the ride-share movable object. Therefore, the delivery system disclosed in Japanese Patent Laid-Open No. 2004-59213 has room for improvement in the utilization of the ride-share movable object in the delivery of articles.

Therefore, an object of the present invention is to make it possible to more efficiently utilize the ride-share movable object in the delivery of articles.

### SUMMARY OF THE INVENTION

In order to achieve the above object, an aspect of the present invention is to provide a delivery request system that requests an operator of a ride-share movable object to deliver an article, the delivery request system including: a first extraction unit that extracts a deliverable ride-share movable object, which is the ride-share movable object capable of delivering the article, based on a ride-share status of the ride-share movable object, a position of the ride-share movable object, and a delivery time or a delivery amount of the article; and a first request unit that makes a delivery request for the article to the operator of the deliverable ride-share movable object extracted by the first extraction unit, the first extraction unit being configured to extract, as the deliverable ride-share movable object, the ride-share movable object being ride-shared at the delivery time, when a transportation influence time is within a predetermined time or when an empty space of the ride-share movable object is larger than a required delivery capacity, the transportation influence time being a time during which delivery of the article affects transportation of passengers, the required delivery capacity being capacity required for the delivery of the article.

In the delivery request system, the delivery request system may further include a payment fee determination unit that increases a delivery request fee paid to the operator, when the first request unit makes the delivery request to the driver of the ride-share movable object being ride-shared.

In the delivery request system, the delivery request system may further include: a ride-share request receiving unit that receives a ride-share request from an applicant who desires to share a ride; a second extraction unit that extracts a ride-sharable movable object that is a ride-share movable object in which the applicant can be ride-shared, based on the ride-share request being received by the ride-share request receiving unit; and a second request unit that makes a transportation request of the applicant to the operator of the ride-sharable movable object extracted by the second extraction unit, and the second extraction unit may extract, as the ride-sharable movable object, the ride-share movable object that delivers the article requested for delivery by the first request unit at a desired ride-share time of the applicant, when a delivery influence time is within a predetermined time, the delivery influence time being a time during which transportation of the applicant affects the delivery of the article.

In the delivery request system, the delivery request system may further include a payment fee determination unit that reduces the delivery request fee paid to the operator, when the second request unit makes the transportation request to the operator of the ride-share movable object that delivers the article requested for delivery by the first request unit at the desired ride-share time of the applicant.

In the delivery request system, the first extraction unit may be configured to: extract the deliverable ride-share movable object based on a ride-share status of the ride-share movable object, a position of the ride-share movable object, a delivery time or a delivery amount of the article, and a delivery condition of the article, and extract, as the deliverable ride-share movable object, the ride-share movable object provided with a refrigerated storage compartment, when the delivery condition indicates a cold storage.

In the delivery request system, the first extraction unit may be configured to extract, as the deliverable ride-share movable object, the ride-share movable object provided with the refrigerated storage compartment supplied with electricity, when the refrigerated storage compartment requires electricity for the cold storage.

In the delivery request system, the first extraction unit may be configured to: determine whether there is the refrigerated storage compartment capable of being rented to the operator, when the ride-share movable object provided with the refrigerated storage compartment is not capable of being extracted as the deliverable ride-share movable object, and extract, as the deliverable ride-share movable object, the ride-share movable object not provided with the refrigerated storage compartment, when the first extraction unit determines that there is the refrigerated storage compartment capable of being rented.

In order to achieve the above object, another aspect of the present invention is a control method of a delivery request system that requests an operator of a ride-share movable object to deliver an article, the control method including: an extraction step of extracting a deliverable ride-share movable object, which is the ride-share movable object capable of delivering the article, based on a ride-share status of the ride-share movable object, a position of the ride-share movable object, and a delivery time or a delivery amount of the article; and a delivery request step of making a delivery request for the article to the operator of the deliverable ride-share movable object extracted in the extraction step, the extraction step including extracting, as the deliverable ride-share movable object, the ride-share movable object being ride-shared at the delivery time, when a transportation influence time is within a predetermined time or when an empty space of the ride-share movable object is larger than a required delivery capacity, the transportation influence time being a time during which delivery of the article affects transportation of passengers, the required delivery capacity being capacity required for the delivery of the article.

According to the aspects of the present invention, there is an effect that the ride-share movable object can be more efficiently utilized in the delivery of articles.

### BRIEF DESCRIPTION OF THE DRAWINGS

FIG. 1 is an explanatory diagram showing an outline of a delivery request system;

FIG. 2 is a diagram showing a configuration of the delivery request system;

FIG. 3 is a flowchart showing an operation of the delivery request system;

FIG. 4 is a flowchart showing an operation of a deliverable ride-share vehicle extraction unit in the extracting process; and

FIG. 5 is a flowchart showing an operation of the delivery request system.

### DETAILED DESCRIPTION OF THE PREFERRED EMBODIMENT

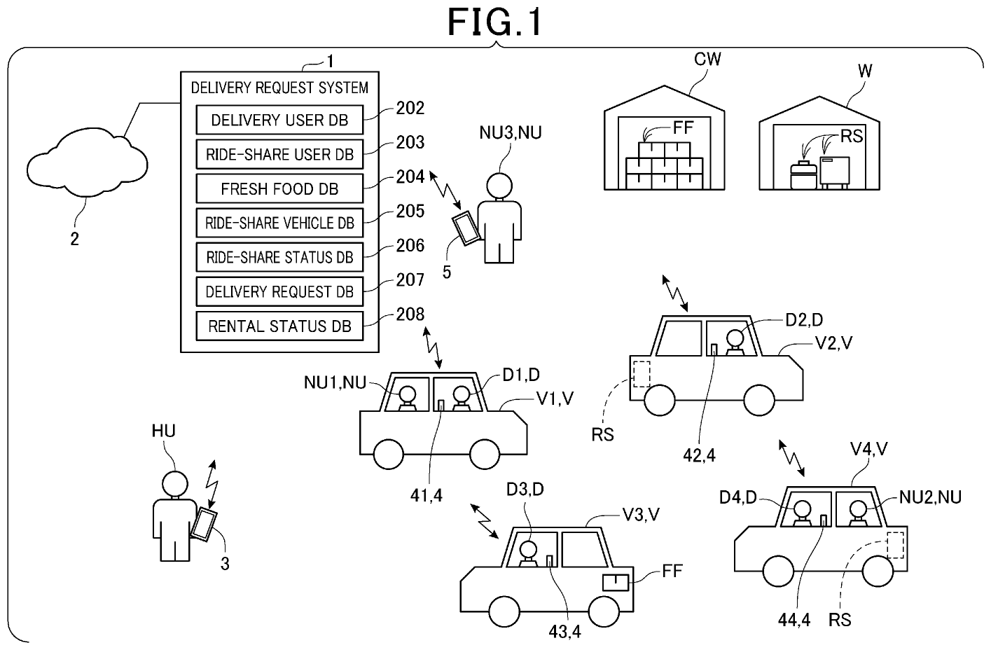

An outline of a delivery request system 1 will be described with reference to FIG. 1. FIG. 1 illustrates an aspect in which the delivery request system 1 performs a delivery request for delivering fresh food FF to a driver D of a ride-share vehicle V. In an example of FIG. 1, the fresh food FF to be delivered to a delivery user HU is stored in a cold-storage warehouse CW.

The fresh food FF corresponds to an article of the present disclosure. The ride-share vehicle V corresponds to an example of a ride-share movable object of the present disclosure. The driver D corresponds to an example of an operator.

The delivery request system 1 of FIG. 1 is configured with a computer and provides a transportation service in which the driver D of the ride-share vehicle V delivers the fresh food FF to the delivery user HU who has registered delivery user with the delivery request system 1. Further, the delivery request system 1 of FIG. 1 provides a transportation service in which a ride-share vehicle V is used by a ride-share user NU who has registered the use of the ride-share vehicle V with the delivery request system 1.

Information of the ride-share vehicle V is recorded in a ride-share vehicle DB (database) 205. Information related to a ride-share status of the ride-share vehicle V, a current position of the ride-share vehicle V, a ride-share user NU who is using the ride-share vehicle V, and the like are recorded in a ride-share status DB 206 in real time. In the present embodiment, the ride-share vehicle V exemplifies a rideshare four-wheeled vehicle by ride sharing, but may be a rideshare four-wheeled vehicle by car sharing, a taxi, or the like.

In the example of FIG. 1, a case is shown where ride-share vehicles V1, V2, V3, and V4 are registered in the delivery request system 1. In the ride-share vehicle V1 of FIG. 1, a driver D1 and a ride-share user NU1 are riding, and the driver D1 is transporting the ride-share user NU1. In the ride-share vehicle V2 of FIG. 1, only a driver D2 is riding, but not ride-share user NU is riding. In the ride-share vehicle V3 of FIG. 1, only a driver D3 is riding, but no ride-share user NU is riding. In the ride-share vehicle V4 of FIG. 1, a driver D4 and a ride-share user NU2 are riding, and the driver D4 is transporting the ride-share user NU2. In the example of FIG. 1, the ride-share vehicles V1, V2, and V4 do not deliver the fresh food FF, while the ride-share vehicle V3 delivers the fresh food FF.

In the example of FIG. 1, each of the ride-share vehicles V2 and V4 includes a refrigerated storage compartment RS which is a storage compartment capable of performing cold storage. The refrigerated storage compartment RS provided in the ride-share vehicle V2 is a storage compartment capable of performing the cold storage by electricity supply. On the other hand, the refrigerated storage compartment RS provided in the ride-share vehicle V4 is a storage compartment capable of performing cold preservation by, for example, an intake of refrigerant, in other words, uncapable of performing the cold storage by electricity supply. Information on whether the refrigerated storage compartment RS is in the electricity supply state is recorded in the ride-share vehicle DB 205. In the example of FIG. 1, both the ride-share vehicles V1 and V3 do not include the refrigerated storage compartment RS. Therefore, in a case of delivering the fresh food FF under delivery condition of cold storage, the refrigerated storage compartment RS is rented out to the drivers D1 and D3. The refrigerated storage compartment RS for rent is stored in a warehouse W. A rental status of the refrigerated storage compartment RS in the warehouse W is recorded in a rental status DB 208 in real time.

The delivery request system 1 communicates with a delivery user terminal 3 used by the delivery user HU via a communication network 2 such as the Internet or a wide area communication network. The delivery user terminal 3 is a terminal device such as a smartphone. The delivery user HU has registered the use of delivery with the delivery request system 1. Information on the delivery user HU is recorded in a delivery user DB 202. The delivery request system 1 provides information on the fresh food FF capable of being delivered to the delivery user HU. The information on the fresh food FF is recorded in a fresh food DB 204. The delivery user HU operates the delivery user terminal 3 to select fresh food FF desired to be delivered, and makes a delivery request for the selected fresh food FF to the delivery request system 1.

The delivery request system 1 communicates with the driver terminals 41, 42, 43, and 44, which are used by the drivers D1, D2, D3, and D4, respectively, via the communication network 2. Each of the driver terminals 41, 42, 43, and 44 is a terminal device such as a smartphone. Upon receiving the delivery request from the delivery user HU, the delivery request system 1 extracts the ride-share vehicle V capable of delivering the fresh food FF from the registered ride-share vehicles V1, V2, V3, and V4.

The delivery request system 1 makes a delivery request to the driver D of the extracted ride-share vehicle V to deliver the fresh food FF to a delivery destination designated by the delivery user HU. At the time of the delivery request, the delivery request system 1 transmits delivery request information indicating the content of the delivery request to the driver terminal 4. The driver D goes to the cold-storage warehouse CW to pick up the fresh food FF based on the delivery request information received by the driver terminal 4, and delivers the fresh food FF obtained in the cold-storage warehouse CW to the delivery destination designated by the delivery user HU. If necessary, the driver D delivers the fresh food FF in a cold storage state with the refrigerated storage compartment RS. Further, the driver D goes to the warehouse W to pick up the refrigerated storage compartment RS for rent as necessary, and delivers the fresh food FF in a cold storage state with the rented refrigerated storage compartment RS. In order to avoid damage or loss of the fresh food FF, the driver D of the present embodiment delivers the fresh food FF while accommodating it in the storage compartment such as the refrigerated storage compartment RS at the time of the delivery of the fresh food FF. The storage compartment such as the refrigerated storage compartment RS is provided in a trunk or a cargo bed of the ride-share vehicle V, for example.

The delivery request system 1 communicates with a ride-share user terminal 5, which is used by the ride-share user NU, via the communication network 2. The ride-share user terminal 5 is a terminal device such as a smartphone. The ride-share user NU has registered the use of the ride-share vehicle V with the delivery request system 1. Information on the ride-share user NU is recorded in a ride-share user DB 203. The ride-share user NU operates the ride-share user terminal 5 to input a desired ride-share time and the like and makes a ride-share request to the delivery request system 1. In the example of FIG. 1, a case is shown in which the ride-share user NU3 makes a ride-share request to the delivery request system 1, as a person who desires to be ride-shared.

Upon receiving the ride-share request from the ride-share user NU via the communication network 2, the delivery request system 1 extracts the ride-share vehicle V capable of being ride-shared from the registered ride-share vehicles V1, V2, V3, and V4. The delivery request system 1 makes a transportation request to the driver D of the extracted ride-share vehicle V to transport the ride-share user NU who makes the ride-share request. At the time of the transportation request, the delivery request system 1 transmits transportation request information indicating transportation contents such as a ride-share plan to the driver terminal 4. Based on the transportation request information received by the driver terminal 4, the driver D transports the ride-share user NU who desires to be ride-shared to the destination using the ride-share vehicle V.

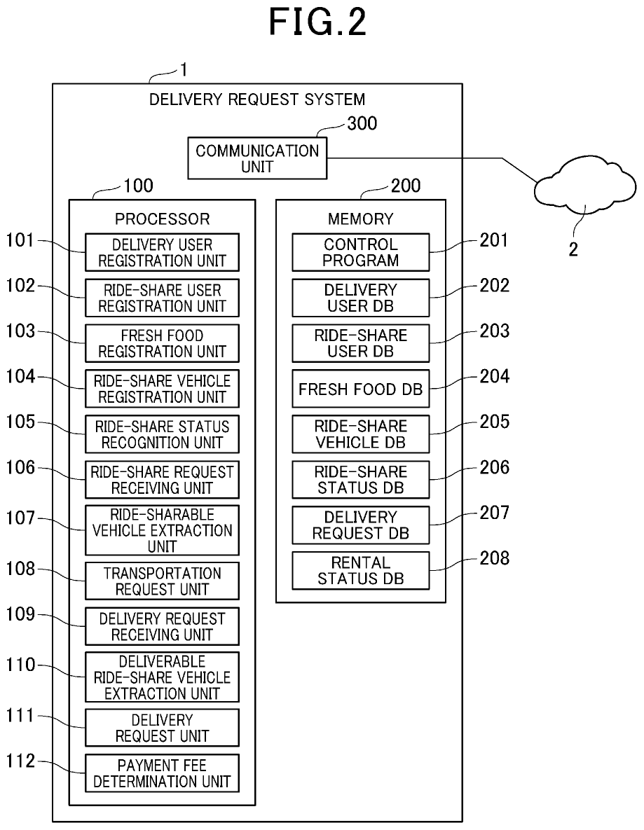

A configuration of the delivery request system 1 will be described with reference to FIG. 2.

FIG. 2 is a diagram showing a configuration of the delivery request system 1.

Referring to FIG. 2, the delivery request system 1 is a computer system including a processor 100 such as a central processing unit (CPU) and a micro-processing unit (MPC), a memory 200, a communication unit 300, and the like. The delivery request system 1 communicates with the delivery user terminal 3, the driver terminal 4, and the ride-share user terminal 5 by the communication unit 300 via the communication network 2.

The processor 100 reads and executes a control program 201 stored in the memory 200 and functions as a delivery user registration unit 101, a ride-share user registration unit 102, a fresh food registration unit 103, a ride-share vehicle registration unit 104, a ride-share status recognition unit 105, a ride-share request receiving unit 106, a ride-sharable vehicle extraction unit 107, a transportation request unit 108, a delivery request receiving unit 109, a deliverable ride-share vehicle extraction unit 110, a delivery request unit 111, and a payment fee determination unit 112.

The deliverable ride-share vehicle extraction unit 110 corresponds to a first extraction unit of the present disclosure. Further, the ride-sharable vehicle extraction unit 107 corresponds to a second extraction unit of the present disclosure. Further, the delivery request unit 111 corresponds to a first request unit of the present disclosure. In addition, the transportation request unit 108 corresponds to a second request unit of the present disclosure.

The memory 200 stores a program executed by the processor 100 and data to be processed by the processor 100. The memory 200 stores the control program 201, the delivery user DB 202, the ride-share user DB 203, the fresh food DB 204, the ride-share vehicle DB 205, the ride-share status DB 206, the delivery request DB 207, the rental status DB 208, and various data which are executed by the processor 100. The memory 200 includes a non-volatile storage region. The memory 200 may include a volatile storage region and from a work area of the processor 100.

The communication unit 300 (transceiver and receiver) includes an antenna and a wireless communication device including an RF circuit, an encoder, a decoder, and the like. The communication unit 300 executes data communication with the delivery user terminal 3, the driver terminal 4, and the ride-share user terminal 5.

The delivery user registration unit 101 registers the delivery user HU with the delivery request system 1. The delivery user HU is registered by recording the information on the delivery user HU in the delivery user DB 202.

The delivery user registration unit 101 records, as the information on the delivery user HU, an identification (ID) issued to the delivery user HU, a name of the delivery user HU, communication information for communicating with the delivery user terminal 3, and the like, in the delivery user DB 202.

The ride-share user registration unit 102 registers the ride-share user NU with the delivery request system 1. The ride-share user NU is registered by recording the information on the ride-share user NU in the ride-share user DB 203.

The ride-share user registration unit 102 records, as the information on the ride-share user NU, an ID issued to the ride-share user NU, a name of the ride-share user NU, communication information for communicating with the ride-share user terminal 5, and the like, in the ride-share user DB 203.

The fresh food registration unit 103 registers the fresh food FF with the delivery request system 1. The fresh food FF is registered by recording the information on the fresh food FF in the fresh food DB 204.

The fresh food registration unit 103 records, as the information on the fresh food FF, an ID issued to the fresh food FF, a name of the fresh food FF, a storage place of the fresh food FF, a delivery condition of the fresh food FF, a size of the fresh food FF, a volume or a dimension of a box in a case of boxing, and the like, in the fresh food DB 204. In the present embodiment, the storage place of the fresh food FF indicates an address of the cold-storage warehouse CW. In the present embodiment, the delivery condition of the fresh food FF indicates whether the cold storage is required.

The ride-share vehicle registration unit 104 registers the ride-share vehicle V with the delivery request system 1. The ride-share vehicle V is registered by recording the information on the ride-share vehicle V in the ride-share vehicle DB 205.

The ride-share vehicle registration unit 104 records, as the information on the ride-share vehicle V, an ID issued to the ride-share vehicle V, a name of the driver D, communication information for communicating with the driver terminal 4, a vehicle model of the ride-share vehicle V, the total number of passengers, the number of seats, a usable period, the presence or absence of the refrigerated storage compartment RS, an electricity supply state of the refrigerated storage compartment RS indicating whether electricity is supplied, and the like, in the ride-share vehicle DB 205. The ride-share vehicle registration unit 104 appropriately updates, based on operation data of the refrigerated storage compartment RS appropriately transmitted from the driver terminal 4, the electricity supply state of the refrigerated storage compartment RS. The operation data of the refrigerated storage compartment RS may be data of an in-compartment temperature sensor provided in the refrigerated storage compartment RS, may be data indicating power consumption per unit time of the refrigerated storage compartment RS, or may be data indicating power consumption per unit time of the ride-share vehicle V including the refrigerated storage compartment RS.

The ride-share status recognition unit 105 receives ride-share vehicle information transmitted from the driver terminal 4 to recognize a position of the ride-share vehicle V and a status of passengers, and records ride-share status information in the ride-share status DB 206 in real time. The ride-share vehicle status information indicates a current position of the ride-share vehicle V, the number of passengers, the status of the passengers, and the like.

The ride-share status information recorded in the ride-share status DB 206 includes the ID issued to the ride-share vehicle V, the ride-share plan, the current position, the ride-share user NU, a sharing execution time, and the like which are recorded for each of the registered ride-share vehicles V.

The ride-share request receiving unit 106 receives a ride-share request from the ride-share user NU who desires to move by the ride-share vehicle V. The ride-share user NU makes a ride-share request by operating a ride-sharing application provided from the delivery request system 1 on the ride-share user terminal 5. The ride-share request includes, as information, the ID of the ride-share user NU, the riding position, the alighting position, and the desired ride-share time.

The ride-sharable vehicle extraction unit 107 extracts, as a ride-sharable vehicle, the ride-share vehicle V that can be ride-shared by the ride-share user NU who makes the ride-share request. The ride-sharable vehicle extraction unit 107 extracts the ride-sharable vehicle with reference to the ride-share request, the ride-share vehicle DB 205, the ride-share status DB 206, and the delivery request DB 207 received by the ride-share request receiving unit 106. A specific operation of the ride-sharable vehicle extraction unit 107 will be described below.

The transportation request unit 108 creates a ride-share plan to search for the ride-share vehicle V based on the ride-sharable vehicle extracted by the ride-sharable vehicle extraction unit 107 and the ride-share request received by the ride-share request receiving unit 106, and records the ride-share plan in the ride-share status DB 206. Further, the transportation request unit 108 transmits transportation request information indicating the created ride-share plane to the driver terminal 4 used by the driver D of the ride-sharable vehicle, based on the ride-share vehicle DB 205. The driver D, who has received the transportation request information by the driver terminal 4, of the ride-share vehicle V dispatches the ride-share vehicle V according to the ride-share plan. Thus, the ride-share user NU, who makes the ride-share request, can be transported by the ride-share vehicle V and can move to the destination by using the ride-share vehicle V.

The delivery request receiving unit 109 receives a delivery request for the fresh food FF from the delivery user HU. The delivery user HU operates a delivery application provided from the delivery request system 1 on the delivery user terminal 3 to make the delivery request for the fresh food FF. The delivery request includes, as information, an ID of the fresh food FF desired to be delivered, a name of the fresh food FF, the number of deliveries, a delivery destination designated by the delivery user HU, a desired delivery time, and an ID of the delivery user HU.

The deliverable ride-share vehicle extraction unit 110 extracts, as a deliverable ride-share vehicle, a ride-share vehicle V capable of delivering the fresh food FF made the delivery request by the delivery user HU. The deliverable ride-share vehicle extraction unit 110 extracts a deliverable ride-share vehicle with reference to the delivery request received by the delivery request receiving unit 109, the fresh food DB 204, the ride-share vehicle DB 205, the ride-share status DB 206, and the rental status DB 208. A specific operation of the deliverable ride-share vehicle extraction unit 110 will be described below.

The delivery request unit 111 makes a delivery request to the driver D of the deliverable ride-share vehicle extracted by the deliverable ride-share vehicle extraction unit 110. Specifically, the delivery request unit 111 refers to the ride-share vehicle DB 205, and transmits the delivery request information to the driver terminal 4 possessed by the driver D of the ride-share vehicle V extracted as the deliverable ride-share vehicle. Further, when making the delivery request, the delivery request unit 111 records delivery-requested information in the delivery request DB 207. The delivery-requested information recorded in the delivery request DB 207 includes an ID of the ride-share vehicle V of the driver D who has made the delivery request, an ID and a name of the fresh food FF to be delivered, a delivery destination designated by the delivery user HU, the number of deliveries, and a delivery time desired by the delivery user HU.

The payment fee determination unit 112 determines fees to be paid to the driver D. The fees determined by the payment fee determination unit 112 include a delivery request fee for the fresh food FF and a transportation fee for the ride-share user NU. The fees determined by the payment fee determination unit 112 are appropriately paid to the driver D at a predetermined timing.

Next, an operation of the delivery request system 1 will be described. In the description of the operation of the delivery request system 1, two cases will be described as examples including a case where the delivery request system 1 receives the delivery request from the delivery user HU and a case where the delivery request system 1 receives the ride-share request from the ride-share user NU.

### [3-1. Operation in Case of Receiving Delivery Request]

First, a description will be given with respect to the operation of the delivery request system 1 in the case where the delivery request system 1 receives the delivery request from the delivery user HU.

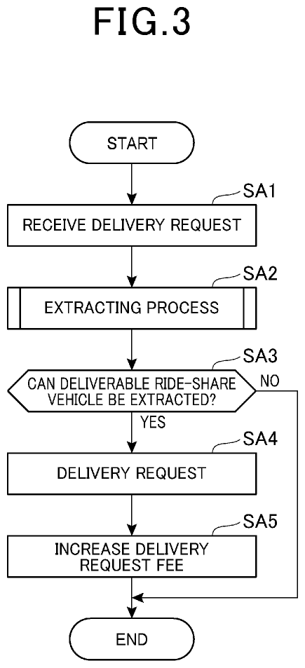

FIG. 3 is a flowchart showing the operation of the delivery request system 1.

The delivery request receiving unit 109 of the delivery request system 1 receives a delivery request for fresh food FF from the delivery user HU (step SA1).

As described above, the delivery request received by the delivery request receiving unit 109 includes, as information, an ID of the fresh food FF which desires to be delivered, a name of the fresh food FF, the number of deliveries, a delivery destination designated by the delivery user HU, a desired delivery time, an ID of the delivery user HU, and the like.

Next, the deliverable ride-share vehicle extraction unit 110 performs an extracting process for extracting the deliverable ride-share vehicle (step SA2). Step SA2 corresponds to an example of the extracting step of the present disclosure.

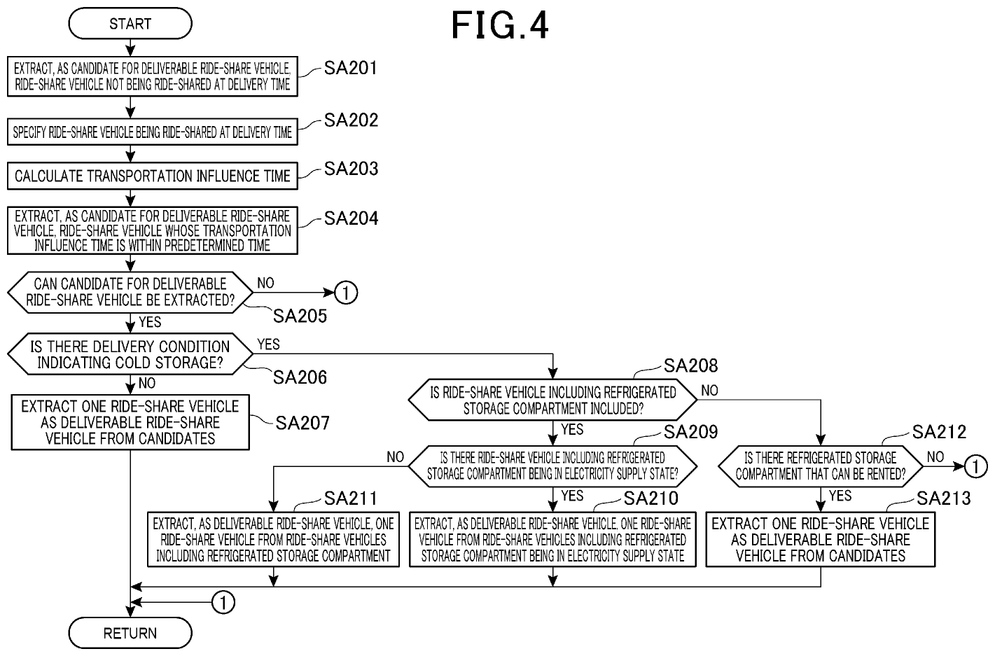

FIG. 4 is a flowchart showing an operation of the deliverable ride-share vehicle extraction unit 110 in the extracting process.

The deliverable ride-share vehicle extraction unit 110 extracts, as a candidate for the deliverable ride-share vehicle, the ride-share vehicle V that is not being ride-shared at the delivery time included in the delivery request received in step SA1, from the ride-share vehicle V registered in the delivery request system 1 (step SA201).

Next, the deliverable ride-share vehicle extraction unit 110 specifies the ride-share vehicle V being ride-shared at the delivery time included in the delivery request received in step SA1, from the ride-share vehicle V registered in the delivery request system 1 (step SA202).

Next, the deliverable ride-share vehicle extraction unit 110 calculates a transportation influence time for each the ride-share vehicle V specified in step SA202 (step SA203).

The transportation influence time is a time during which the delivery of the fresh food FF affects the transportation of the passenger, for example, a delay time from the originally scheduled time when the passenger arrives at the destination. The transportation influence time is calculated based on, for example, a position of the cold-storage warehouse CW, a current position of the ride-share vehicle V, a position of the delivery destination included in the delivery request, and the like.

Next, the deliverable ride-share vehicle extraction unit 110 extracts, as a candidate for the deliverable ride-share vehicle, the ride-share vehicle V of which calculated transportation influence time is within a predetermined time from the ride-share vehicles V specified in step SA202 (step SA204).

The predetermined time to be compared with the transportation influence time is appropriately determined by a pretest, a simulation, or the like, from the viewpoint that it affects the transportation of the ride-share user NU.

The deliverable ride-share vehicle extraction unit 110 determines whether a candidate for the deliverable ride-share vehicle can be extracted (step SA205).

The deliverable ride-share vehicle extraction unit 110 ends the extracting process when determines that the candidate for the deliverable ride-share vehicle cannot be extracted (NO in step SA205).

When it is determined that the candidate for the deliverable ride-share vehicle can be extracted (YES in step SA205), the deliverable ride-share vehicle extraction unit 110 determines with reference to the fresh food DB 204 whether the delivery condition of the fresh food FF of the delivery request indicates a cold storage (step SA206).

When it is determined that the delivery condition does not indicate the cold storage (NO in step SA206), the deliverable ride-share vehicle extraction unit 110 extracts one ride-share vehicle V as the deliverable ride-share vehicle from the ride-share vehicles V extracted as a candidate (step SA207).

For example, the deliverable ride-share vehicle extraction unit 110 extracts the ride-share vehicle V having the shortest required delivery time based on the current position of the ride-share vehicle V, the position of the cold-storage warehouse CW, and the position of the delivery destination.

On the other hand, when it is determined that the delivery condition indicates the cold storage (YES in step SA206), the deliverable ride-share vehicle extraction unit 110 determines whether the ride-share vehicle V extracted as the candidate includes the ride-share vehicle V provided with the refrigerated storage compartment RS (step SA208).

When it is determined that the ride-share vehicle V provided with the refrigerated storage compartment RS is included (YES in step SA207), the deliverable ride-share vehicle extraction unit 110 determines with reference to the ride-share vehicle DB 205 whether the ride-share vehicles V provided with the refrigerated storage compartment RS include the ride-share vehicle V provided with the refrigerated storage compartment RS being in the electricity supply state (step SA209).

When it is determined that the ride-share vehicle V provided with the refrigerated storage compartment RS being in the electricity supply state is not included (NO in step SA209), the deliverable ride-share vehicle extraction unit 110 extracts, as a deliverable ride-share vehicle, one ride-share vehicle V from the ride-share vehicles V provided with the refrigerated storage compartment RS (step SA210).

For example, the deliverable ride-share vehicle extraction unit 110 extracts the ride-share vehicle V having the shortest required delivery time, based on the current position of the ride-share vehicle V, the position of the cold-storage warehouse CW, and the position of the delivery destination.

On the other hand, when it is determined that the ride-share vehicle V provided with the refrigerated storage compartment RS being in the electricity supply state is included (YES in step SA209), the deliverable ride-share vehicle extraction unit 110 extracts, as a deliverable ride-share vehicle, one ride-share vehicle V from the ride-share vehicles V provided with the refrigerated storage compartment RS being in the electricity supply state (step SA211).

For example, the deliverable ride-share vehicle extraction unit 110 extracts the ride-share vehicle V having the shortest required delivery time based on the current position of the ride-share vehicle V, the position of the cold-storage warehouse CW, and the position of the delivery destination.

Returning to the description of step SA208, when it is determined that ride-share vehicle V provided with the refrigerated storage compartment RS is not included (NO in step SA208), the deliverable ride-share vehicle extraction unit 110 determines with reference to the rental status DB 208 whether the warehouse W includes the refrigerated storage compartment RS that can be rented (step SA212).

When it is determined that the warehouse W does not include the refrigerated storage compartment RS that can be rented (NO in step SA212), the deliverable ride-share vehicle extraction unit 110 ends the extracting process.

On the other hand, when it is determined that the warehouse W includes the refrigerated storage compartment RS that can be rented (YES in step SA212), the deliverable ride-share vehicle extraction unit 110 extracts, as a deliverable ride-share vehicle, one ride-share vehicle V from the ride-share vehicles V extracted as the candidate (step SA213).

For example, the deliverable ride-share vehicle extraction unit 110 extracts the ride-share vehicle V having the shortest required delivery time based on the current position of the ride-share vehicle V, the position of the cold-storage warehouse CW, and the position of the delivery destination.

In the extracting process described above, the deliverable ride-share vehicle extraction unit 110 is configured to extract the deliverable ride-share vehicle based on the transportation influence time. In the extracting process, the deliverable ride-share vehicle extraction unit 110 may extract the deliverable ride-share vehicle based on an empty space of the ride-share vehicle V instead of the transportation influence time.

Extraction based on the empty space of the ride-share vehicle V will be described below.

The deliverable ride-share vehicle extraction unit 110 calculates the empty space of the ride-share vehicle for each of the ride-share vehicles V registered in the delivery request system 1.

The deliverable ride-share vehicle extraction unit 110 calculates the empty space of the ride-share vehicle V based on the ride-share vehicle DB 205 and the ride-share status DB 206. For example, the deliverable ride-share vehicle extraction unit 110 calculates the empty space of the ride-share vehicle V based on the vehicle model recorded in the ride-share vehicle DB 205, the total number of passengers recorded in the ride-share vehicle DB 205, and the number of passengers recorded in the ride-share status DB 206. The deliverable ride-share vehicle extraction unit 110 may calculate the empty space of the ride-share vehicle V in units of volume or in units of the number of seats.

Next, the deliverable ride-share vehicle extraction unit 110 calculate a required delivery capacity which is a capacity required for the delivery of the fresh food FF. The deliverable ride-share vehicle extraction unit 110 calculates the required delivery capacity based on the delivery amount of the fresh food FF. The delivery amount of the fresh food FF indicates the amount of the fresh food FF to be delivered, and indicates the size of the fresh food FF, the volume of the fresh food FF, the dimension of the fresh food FF, the quantity of the fresh food FF to be delivered, and the loading capacity of the fresh food FF to be delivered. For example, the deliverable ride-share vehicle extraction unit 110 calculates the required delivery capacity of the fresh food FF based on the number of deliveries (the quantity of the fresh food FF to be delivered) indicated by the delivery request received by the delivery request receiving unit 109 and the size of the fresh food FF recorded in the fresh food DB 204. The deliverable ride-share vehicle extraction unit 110 may calculate the required delivery capacity in units of volume or in units of the number of seats. However, the unit of the required delivery capacity calculated by the deliverable ride-share vehicle extraction unit 110 is preferably the same as the unit of the ride-share vehicle empty space.

The deliverable ride-share vehicle extraction unit 110 extracts, as a candidate for the deliverable ride-share vehicle, the ride-share vehicle V having the calculated empty space of the ride-share vehicle V larger than the calculated required delivery capacity. Then, the deliverable ride-share vehicle extraction unit 110 performs processes as in the processes in step SA205 and subsequent steps in FIG. 4. The deliverable ride-share vehicle extraction unit 110 does not extract, as a candidate for the deliverable ride-share vehicle, the ride-share vehicle V having the calculated empty space of the ride-share vehicle V equal to or smaller than the calculated required delivery capacity. This is because when the required delivery amount is equal to or larger than the empty space of the ride-share vehicle V, the space for the passengers in the ride-share vehicle V is narrowed, which affects the passengers.

For example, when the deliverable ride-share vehicle extraction unit 110 calculates that the number of seats is two as the empty space of the ride-share vehicle V and the number of seats is one as the required delivery capacity for any ride-share vehicle V, such any ride-share vehicle V is extracted as a candidate for the deliverable ride-share vehicle. For example, the deliverable ride-share vehicle extraction unit 110 calculates that the number of seats is one as the empty space of the ride-share vehicle V and the number of seats is two as the required delivery capacity for any ride-share vehicle V, such any ride-share vehicle V is not extracted as a candidate for the deliverable ride-share vehicle.

Returning to the description of FIG. 3, the delivery request unit 111 determines whether the deliverable ride-share vehicle extraction unit 110 can extract the deliverable ride-share vehicle by the extracting process (step SA3).

When the delivery request unit 111 determines that the deliverable ride-share vehicle extraction unit 110 cannot extract the deliverable ride-share vehicle (NO in step SA3), the process ends.

On the other hand, when it is determined that the deliverable ride-share vehicle extraction unit 110 can extract the deliverable ride-share vehicle (YES in step SA4), the delivery request unit 111 makes a delivery request to the driver D of the deliverable ride-share vehicle (step SA4). Step SA4 corresponds to an example of a delivery request step of the present disclosure.

For example, it is assumed that the delivery user HU in FIG. 1 makes a delivery request for the fresh food FF and the deliverable ride-share vehicle extraction unit 110 extracts the ride-share vehicle V2. The delivery condition of the fresh food FF indicates the cold storage. In this case, the delivery request unit 111 transmits the following delivery request information to the driver terminal 42, for example. In other words, the delivery request information to be transmitted indicates the ID and the name of the fresh food FF to be delivered, the address of the cold-storage warehouse CW where the fresh food FF is stored, the delivery destination designated by the delivery user HU, the instruction for cold storage of the fresh food FF by the refrigerated storage compartment RS, and the like.

In addition, for example, it is assumed that the delivery user HU in FIG. 1 makes a delivery request for the fresh food FF and the deliverable ride-share vehicle extraction unit 110 extracts the ride-share vehicle V1. The delivery condition of the fresh food FF indicates the cold storage. In this case, the delivery request unit 111 transmits the following delivery request information to the driver terminal 41, for example. In other words, the delivery request information to be transmitted indicates the ID and the name of the fresh food FF to be delivered, the address of the cold-storage warehouse CW where the fresh food FF is stored, the instruction to receive the refrigerated storage compartment RS at the warehouse W, the address of the warehouse W, the delivery destination designated by the delivery user HU, the instruction for cold storage of the fresh food FF by the refrigerated storage compartment RS received at the warehouse W, and the like.

In addition, for example, it is assumed that the delivery user HU in FIG. 1 makes a delivery request for the fresh food FF and the deliverable ride-share vehicle extraction unit 110 extracts the ride-share vehicle V1. The delivery condition of the fresh food FF does not indicate the cold storage. In this case, the delivery request unit 111 transmits the following delivery request information to the driver terminal 42, for example. In other words, the delivery request information to be transmitted indicates the ID and the name of the fresh food FF to be delivered, the address of the cold-storage warehouse CW where the fresh food FF is stored, the delivery destination designated by the delivery user HU, and the like.

Returning to the description of the step, subsequently, the payment fee determination unit 112 increases the delivery request fee paid to the driver D who has made the delivery request in step SA4 (step SA5). The delivery request fee to be increased is a delivery request fee related to the delivery request made in step SA4. The degree of increase may differ depending on various factors such as the number of deliveries.

### [3-2. Operation in Case of Receiving Ride-Share Request]

First, a description will be given with respect to the operation of the delivery request system 1 in the case where the delivery request system 1 receives the ride-share request.

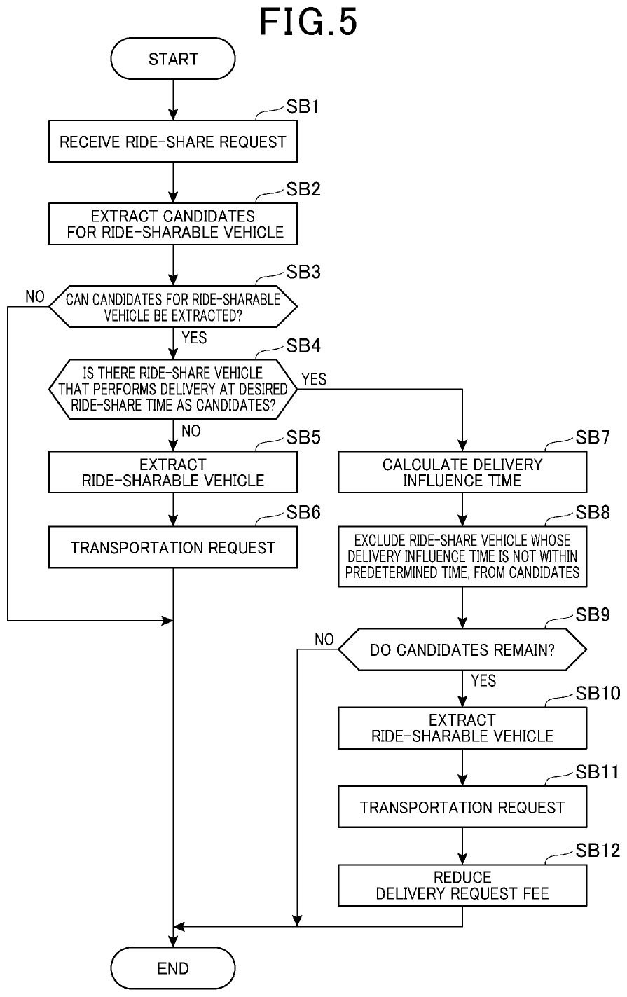

FIG. 5 is a flowchart showing the operation of the delivery request system 1.

The ride-share request receiving unit 106 of the delivery request system 1 receives a ride-share request from the ride-share user NU (step SB1). As described above, the ride-share request includes, as information, the ID, the riding position, the alighting position, and the desired ride-share time of the ride-share user NU.

Next, the ride-sharable vehicle extraction unit 107 extracts a candidate for the ride-sharable vehicle from the ride-share vehicles V registered in the delivery request system 1, based on the ride-share request received by the ride-share request receiving unit 106 (step SB2). For example, the ride-sharable vehicle extraction unit 107 extracts, as a ride-sharable vehicle, the ride-share vehicle V that is not ride-shared at the same time as the desired ride-share time indicated by the ride-share request received in step SB1.

The ride-sharable vehicle extraction unit 107 determines whether the candidate for the ride-sharable vehicle can be extracted (step SB3). When it is determined that the candidate for the ride-sharable vehicle cannot be extracted (NO in step SB3), the ride-sharable vehicle extraction unit 107 ends this process.

When it is determined that the candidate for the ride-sharable vehicle can be extracted (YES in step SB3), the ride-sharable vehicle extraction unit 107 determines whether there is a ride-share vehicle V that delivers the fresh food FF at the desired ride-share time indicated by the ride-share request received in step SB1 (step SB4).

When it is determined that there is no ride-share vehicle V that delivers the fresh food FF (NO in step SB4), the ride-sharable vehicle extraction unit 107 extracts one ride-share vehicle as a ride-sharable vehicle from the candidates for the ride-sharable vehicle (step SB5). For example, the ride-sharable vehicle extraction unit 107 extracts the ride-share vehicle V located closest to the riding position of the ride-share user NU, based on the current position of the ride-share vehicle V and the riding position of the ride-share user NU.

Then, the transportation request unit 108 makes a delivery request to the driver D of the ride-sharable vehicle extracted in step SB5 (step SB6).

When it is determined that there is a ride-share vehicle V that delivers the fresh food FF (NO in step SB4), the ride-sharable vehicle extraction unit 107 calculates a delivery influence time for each of the ride-share vehicles V that deliver the fresh food FF (step SB7).

The delivery influence time is a time during which the transportation of the ride-share user NU affects the delivery of the fresh food FF, for example, a delay time from the originally scheduled time of arrival at the delivery destination. The delivery influence time is calculated based on the desired ride-share time indicated by the ride-share request, the riding position indicated by the ride-share request, the alighting position indicated by the ride-share request.

The ride-sharable vehicle extraction unit 107 excludes the ride-share vehicle V whose calculated delivery influence time is not within the predetermined time, from the candidates (step SB8).

The ride-sharable vehicle extraction unit 107 determines whether the candidates for the ride-sharable vehicle remain (step SB9).

When it is determined that no candidates for the ride-sharable vehicle remain (NO in step SB9), the ride-sharable vehicle extraction unit 107 end this process.

On the other hand, when it is determined that the candidates for the ride-sharable vehicle remain (YES in step SB9), the ride-sharable vehicle extraction unit 107 extracts one ride-share vehicle V as a ride-sharable vehicle from the remaining candidates (step SB10). For example, the ride-sharable vehicle extraction unit 107 extracts the ride-share vehicle V located closest to the riding position of the ride-share user NU, based on the current position of the ride-share vehicle V and the riding position of the ride-share user NU.

Next, the transportation request unit 108 makes a transportation request to the driver D of the extracted ride-sharable vehicle (step SB11).

Next, the payment fee determination unit 112 reduces the delivery request fee paid to the driver D who has made the transportation request in step SB11 (step SB12). The delivery request fee to be reduced is a delivery request fee related to the delivery request which has already made. The degree of reduction may differ depending on the delivery time zone such as at night and the number of deliveries and the like.

According to the present embodiment, the following effects are obtained.

The delivery request system 1 of the present embodiment is a system that requests the driver D of the ride-share vehicle V to deliver the fresh food FF. The delivery request system 1 includes the deliverable ride-share vehicle extraction unit 110 that extracts the deliverable ride-share vehicle based on the ride-share status of the ride-share vehicle V, the position of the ride-share vehicle V, and the delivery time or the delivery amount of the fresh food FF, and the delivery request unit 111 that makes the delivery request for the fresh food FF to the driver D of the deliverable ride-share vehicle extracted by the deliverable ride-share vehicle extraction unit 110. The deliverable ride-share vehicle extraction unit 110 extracts the ride-share vehicle V being ride-shared at the delivery time as the deliverable ride-share vehicle when the transportation influence time, which is the time during which the delivery of the fresh food FF affects the transportation of the passengers, is within the predetermined time or when the empty space of the ride-share vehicle V is larger than the required delivery capacity.

A control method of the delivery request system 1 of the present embodiment includes an extraction step of extracting the deliverable ride-share vehicle based on the ride-share status of the ride-share vehicle V, the position of the ride-share vehicle V, and the delivery time or the delivery amount of the fresh food FF, and a request step of making the delivery request for the fresh food FF to the driver D of the deliverable ride-share vehicle extracted in the extraction step. In extraction step, the ride-share vehicle V being ride-shared at the delivery time is extracted as the deliverable ride-share vehicle when the transportation influence time, which is the time during which the delivery of the fresh food FF affects the transportation of the passengers, is within the predetermined time or when the empty space of the ride-share vehicle V is larger than the required delivery capacity.

According to the delivery request system 1 and the control method of the delivery request system 1, it is possible to make the delivery request to the ride-share vehicle V being ride-shared while reducing the influence on the passengers in terms of the time or the riding space. Therefore, the restriction of the delivery request to the ride-share vehicle V being ride-shared can be relaxed, and the ride-share vehicle V can be more effectively utilized in the delivery of the fresh food FF.

Further, since the ride-share vehicle V can be more effectively utilized in the delivery of the fresh food FF, the driver D of the ride-share vehicle V can obtain more income from the delivery of the fresh food FF. Therefore, the delivery request system 1 can enhance the delivery motivation of the driver D. Then, since the delivery number of fresh foods FF can be increased, the delivery request system 1 can reduce the food loss of the fresh food FF in the cold-storage warehouse CW.

The delivery request system 1 of the present embodiment includes the payment fee determination unit 112 that increases the delivery request fee paid to the driver D when the delivery request unit 111 makes the delivery request to the driver D of the ride-share vehicle V being ride-shared.

With such a configuration, the incentive for delivery can be appropriately given to the driver D. Further, the delivery motivation of the driver D can be enhanced.

The delivery request system 1 includes: the ride-share request receiving unit 106 that receives the ride-share request from the ride-share user NU who desires to share a ride; the ride-sharable vehicle extraction unit 107 that extracts the ride-sharable vehicle, in which the ride-share user NU can be ride-sharable, based on the ride-share request received by the ride-share request receiving unit 106; and the transportation request unit 108 that makes the transportation request for the ride-share user NU to the driver D of the ride-sharable vehicle extracted by the ride-sharable vehicle extraction unit 107. The ride-sharable vehicle extraction unit 107 extracts, as the ride-sharable movable object, the ride-share vehicle V that delivers the fresh food FF at the desired ride-share time of the ride-share user NU when the delivery influence time, which is the time during which the transportation of the ride-share user NU affects the delivery of the fresh food FF, is within the predetermined time.

With such a configuration, it is possible to make the transportation request to the ride-share vehicle V that has received the delivery request while reducing the influence on the fresh food FF, so that the delivery request for the fresh food FF and the transportation request for the ride-share user NU can be appropriately made.

The delivery request system 1 includes the payment fee determination unit 112 that reduces the delivery request fee paid to the driver D when the transportation request is made to the driver D of the ride-share vehicle V that delivers the fresh food FF at the desired ride-share time of the ride-share user NU.

With such a configuration, since the movement of the ride-share vehicle V is not limited only to the delivery of the fresh food FF, the delivery request fee can be appropriately adjusted.

The deliverable ride-share vehicle extraction unit 110 extracts the deliverable ride-share vehicle based on the ride-share status of the ride-share vehicle V, the position of the ride-share vehicle V, the delivery time or the delivery amount of the fresh food FF, and the delivery condition of the fresh food FF. The deliverable ride-share vehicle extraction unit 110 extracts, as the deliverable ride-share movable object, the ride-share vehicle V provided with the refrigerated storage compartment RS when the delivery condition of the fresh food FF of the delivery request target indicates the cold storage.

With such a configuration, it is possible to utilize more efficiently the ride-share vehicle V while ensuring the quality of the fresh food FF to be delivered in the delivery of the fresh food FF.

The deliverable ride-share vehicle extraction unit 110 extracts, as the deliverable ride-share vehicle, the ride-share vehicle V provided with the refrigerated storage compartment RS supplied with electricity, when the refrigerated storage compartment RS requires electricity for the cold storage.

With such a configuration, since a cooling effect can be given to the fresh food FF from the start of storage in the refrigerated storage compartment RS, the quality of the fresh food FF to be delivered can be further ensured.

The deliverable ride-share vehicle extraction unit 110 determines whether there is the refrigerated storage compartment RS that can be rented to the driver D when the ride-share vehicle V provided with the refrigerated storage compartment RS cannot be extracted as the deliverable ride-share vehicle, and extracts, as the deliverable ride-share movable object, the ride-share vehicle V provided with no refrigerated storage compartment RS when it is determined that there is the refrigerated storage compartment RS that can be rented to the driver D.

With such a configuration, even when the ride-share vehicle V is not provided with the refrigerated storage compartment RS, it is possible to deliver the fresh food FF while ensuring the quality of the fresh food FF to be delivered.

The above-described embodiment is merely an example of one aspect of the present invention, and can be arbitrarily modified and applicable.

In the above-described embodiment, as an example of the ride-share movable object of the present disclosure, the ride-share vehicle V of the four-wheeled vehicle has been exemplified, the ride-share movable object of the present disclosure may be various riding movable objects, for example, a two-wheeled vehicle, a three-wheeled vehicle, a flying object, and a ship object, as long as being a ride-sharable.

In the above-described embodiment, the fresh food FF is exemplified as the article of the present disclosure. However, the article of the present disclosure is not limited to the fresh food FF, and may be other foods such as processed foods. In addition, the article of the present disclosure is not limited to the foods, and may be other articles such as home appliances, furniture, and stationery.

The delivery user HU is not limited to an end user of the fresh food FF, but may be a manufacturer, a seller, or the like. When the delivery user HU is a manufacturer, the delivery destination of the fresh food FF is, for example, a factory that manufactures the fresh food FF.

The delivery destination described above is, for example, the home of the delivery user HU when the delivery user HU is an end user, and is, for example, a manufacturing factory when the delivery user HU is a manufacturer. In other words, the above-described delivery destination is not necessarily limited to the end user's home or the like.

The above-described embodiment may have a configuration in which the driver D who has received the delivery request transmits a delivery completion notification to the delivery request system 1 using the driver terminal 4, and the delivery request system 1 transmits the delivery completion notification, which is received from the driver terminal 4, to the delivery user terminal 3. With such a configuration, the delivery user HU can confirm that the delivery has been completed. In such a configuration, at the timing when the driver D completes at least the delivery, for example, the driver D may photograph the ride-share vehicle V and may transmit the photographed result as a delivery completion notification to the delivery request system 1. Further, the driver D may transmit reading data of an IC attached to the packaging of the fresh food FF, as a delivery completion notification, instead of the photographed result to the delivery request system 1.

In the above-described embodiment, the delivery request system 1 is configured to make the delivery request and the transportation request to the driver D, but the system for making the delivery request and the transportation request may be configured by different systems capable of communicating with each other.

In the above-described embodiment, the driver terminal 4 transmits the operation data of the refrigerated storage compartment RS to the delivery request system 1, but the operation data of the refrigerated storage compartment RS may be transmitted to the delivery request system 1 by the communication device provided in the ride-share vehicle V. In this case, the communication device provided in the ride-share vehicle V is appropriately connected to an appropriate device so as to acquire the operation data.

Further, FIG. 2 is a schematic diagram showing the functional configuration of the delivery request system 1 by dividing the functional configuration depending on main process contents, and does not limit the configuration of the delivery request system 1. For example, the process of the components of the processor 100 may be executed by one hardware unit, or may be executed by a plurality of hardware units. Each of the processes shown in FIGS. 3 to 5 may be executed by one program, or may be executed by a plurality of programs.

The control program 201 executed by the processor 100 can be realized in a state where the control program 201 is recorded on a portable information recording medium. Examples of the information recording medium include a magnetic recording medium such as a hard disk, an optical recording medium such as a CD, and a semiconductor storage device such as a universal serial bus (USB) memory or a solid state drive (SSD), but other recording media can be used. The processor 100 may read the control program 201 from the information recording medium and execute the read control program 201.

The operation step units shown in FIGS. 3 to 5 are divided depending to main process contents in order to facilitate understanding of the operation of the delivery request system 1, and are not limited by a division method or a name of the process units. The operation step units may be divided into more step units depending on the process contents. In addition, one step unit may be divided so as to include more processes. The order of the steps may be changed as appropriate.

### REFERENCE SIGNS LIST

1 . . . delivery request system, 100 . . . processor, 101 . . . delivery user registration unit, 102 . . . ride-share user registration unit, 103 . . . fresh food registration unit, 104 . . . ride-share vehicle registration unit, 105 . . . ride-share status recognition unit, 106 . . . ride-share request receiving unit, 107 . . . ride-sharable vehicle extraction unit (second extraction unit), 108 . . . transportation request unit (second request unit), 109 . . . delivery request receiving unit, 110 . . . deliverable ride-share vehicle extraction unit (first extraction unit), 111 . . . delivery request unit (first request unit), 112 . . . payment fee determination unit, 200 . . . memory, 201 . . . control program, 202 . . . delivery user DB, 203 . . . ride-share user DB, 204 . . . fresh food DB, 205 . . . ride-share vehicle DB, 206 . . . ride-share status DB, 207 . . . delivery request DB, 208 . . . rental status DB, 300 . . . communication unit, CW . . . cold-storage warehouse, D, D1, D2, D3, D4 . . . driver (operator), FF . . . fresh food (article), RS . . . refrigerated storage compartment, V, V1, V2, V3, V4 . . . ride-share vehicle (ride-share movable object).

What is claimed is:

1. A delivery request system that requests an operator of a ride-share movable object to deliver an article, the delivery request system comprising a processor that:
extracts a deliverable ride-share movable object, which is the ride-share movable object capable of delivering the article, based on a ride-share status of the ride-share movable object, a position of the ride-share movable object, and a delivery time or a delivery amount of the article; and
makes a delivery request for the article to the operator of the deliverable ride-share movable object extracted by the first extraction unit, wherein the processor
extracts, as the deliverable ride-share movable object, the ride-share movable object being ride-shared at the delivery time, when a transportation influence time is within a predetermined time or when an empty space of the ride-share movable object is larger than a required delivery capacity, the transportation influence time being a time during which delivery of the article affects transportation of passengers, the required delivery capacity being capacity required for the delivery of the article.

2. The delivery request system according to claim 1, wherein the processor further:
increases a delivery request fee paid to the operator, when the processor makes the delivery request to the operator of the ride-share movable object being ride-shared.

3. The delivery request system according to claim 1, wherein the processor further:
receives a ride-share request from an applicant who desires to share a ride;
extracts a ride-sharable movable object that is a ride-share movable object in which the applicant can be ride-shared, based on the ride-share request being received by the ride-share request receiving unit; and
makes a transportation request of the applicant to the operator of the ride-sharable movable object extracted by the second extraction unit, wherein
the processor extracts, as the ride-sharable movable object, the ride-share movable object that delivers the article requested for delivery at a desired ride-share time of the applicant, when a delivery influence time is within a predetermined time, the delivery influence time being a time during which transportation of the applicant affects the delivery of the article.

4. The delivery request system according to claim 3, wherein the processor further:
reduces the delivery request fee paid to the operator, when the processor makes the transportation request to the operator of the ride-share movable object that delivers the article requested for delivery at the desired ride-share time of the applicant.

5. The delivery request system according to claim 1, wherein
the processor
extracts the deliverable ride-share movable object based on a ride-share status of the ride-share movable object, a position of the ride-share movable object, a delivery time or a delivery amount of the article, and a delivery condition of the article, and
extracts, as the deliverable ride-share movable object, the ride-share movable object provided with a refrigerated storage compartment, when the delivery condition indicates a cold storage.

6. The delivery request system according to claim 5, wherein
the processor extracts, as the deliverable ride-share movable object, the ride-share movable object provided with the refrigerated storage compartment supplied with electricity, when the refrigerated storage compartment requires electricity for the cold storage.

7. The delivery request system according to claim 5, wherein
the processor
determines whether there is the refrigerated storage compartment capable of being rented to the operator, when the ride-share movable object provided with the refrigerated storage compartment is not capable of being extracted as the deliverable ride-share movable object, and
extracts, as the deliverable ride-share movable object, the ride-share movable object not provided with the refrigerated storage compartment, when the processor determines that there is the refrigerated storage compartment capable of being rented.

8. A control method of a delivery request system that requests an operator of a ride-share movable object to deliver an article, the control method comprising:
an extraction step of extracting a deliverable ride-share movable object, which is the ride-share movable object capable of delivering the article, based on a ride-share status of the ride-share movable object, a position of the ride-share movable object, and a delivery time or a delivery amount of the article; and
a delivery request step of making a delivery request for the article to the operator of the deliverable ride-share movable object extracted in the extraction step,
the extraction step including extracting, as the deliverable ride-share movable object, the ride-share movable object being ride-shared at the delivery time, when a transportation influence time is within a predetermined time or when an empty space of the ride-share movable object is larger than a required delivery capacity, the transportation influence time being a time during which delivery of the article affects transportation of passengers, the required delivery capacity being capacity required for the delivery of the article.
